(19) United States
(12) Patent Application Publication
(10) Pub. No.: US 2002/0157464 A1
(43) Pub. Date: Oct. 31, 2002

(54) External liquid level gauge

(76) Inventor: Joseph Rait, Seattle, WA (US)

Correspondence Address: MARKS & CLERK, 350 BURNHAMTHORPE ROAD WEST, SUITE 402, MISSISSAUGA, ON, L5B 3J1, CA

(21) Appl. No.: 10/077,971

(22) Filed: Feb. 20, 2002

(30) Foreign Application Priority Data
Feb. 26, 2001 (CA) 2,338,407

(51) Int. Cl. G01F 23/00

(52) U.S. Cl. 73/293

(57) ABSTRACT

An external liquid level gauge may be provided for determining the level of the interface between a mass of flowable material and the void volume above it within a container. The external liquid level gauge is adapted to be affixed vertically to the outside wall of the container, extending along substantially the entire height. It is in the form of an elongated strip and comprises a layer of base material and a layer of thermochromatic materials. The thermochromatic layer further comprises a light absorbing background and at least two regions of thermochromatic materials which are arranged upon the light absorbing background. The regions of at least two thermochromatic materials are disposed in arrays thereof and are arranged entirely along the length of the external liquid level gauge. Moreover, each of the thermochromatic materials is arranged in an individual area and each thermochromatic material responds chromatically within a different operating temperature range. The theory is that the rate of heat transfer is different between a mass of flowable material and the void volume above it such that for any container with a modest heat conducting capability, the container wall experiences a temperature gradient which is most pronounced at and below the interface of the contents. Thus, with the use of thermochromatic materials, a vivid color change occurring at and below the interface will permit an observer to obtain a direct reading of the level of the flowable material within a container.

### FIELD OF THE INVENTION:

This invention relates to liquid level measuring devices, and particularly relates to external liquid level gauges for determining the level of the interface between a mass of flowable material and the void volume above it within a container.

### BACKGROUND OF THE INVENTION:

Liquid level measuring devices have been known for many years. Their purpose is to locate the level of a flowable material, or to indicate the amount of flowable material remaining in a container.

On many occasions, monitoring the amount of flowable material in a container is required. However, direct observation of the flowable material level is not always possible or practical. Measurement of the material in such containers as pressurized cylinders, sealed containers, cryogenic flasks, and opaque vessels is often difficult. Such measurements are even more troublesome when the material within the container is corrosive or potentially toxic or flammable.

Sight glasses and weight scales are some examples of liquid level measuring devices which are commonly employed. Both of these devices suffer from a number of disadvantages. Sight glasses are expensive, irremovable from one container to another, and they can crack and break easily. Furthermore, on such occasions where the container is placed outdoors, ultraviolet light can cause the glass to haze. Weight scales also are expensive and they generally are non-transferable. In many instances, measurements provided by weight scales are inexact.

A simple, economical external liquid level gauge which permits a direct reading of the level of a flowable material has been provided by the present inventor in the prior art. This liquid level measuring device is a significant improvement from sight glasses and weight scales. It can be repeatedly removed and reattached to the outside wall of a container. In addition, it requires no alteration of the container or the use of tools or other auxiliary equipment.

While the external liquid level gauge provided in the prior art comprises only one thermochromatic material, the present invention is directed at an external liquid level gauge with at least two thermochromatic materials. Each thermochromatic material is disposed entirely along the length of the gauge which is adapted to be affixed vertically to the outside wall of the container. Since each thermochromatic material responds chromatically within a different temperature range, a slight change in temperature in the region of the external liquid level gauge can be readily discerned visually by a vivid color change.

The theory is that the rate of heat transfer is different between a mass of flowable material and the void volume above it such that for any container with a modest heat conducting capability, the container wall experiences a temperature gradient which is most pronounced at the interface of the contents with the void volume above the contents, and of course below that interface. That is to say, the rate of heat transfer through the wall of a container will be greater where there is a mass of flowable material located in the container than where there is a void volume above the flowable material. In other words, the temperature of the container wall changes most abruptly at the level of the interface, and below. Thus, with the use of thermochromatic materials, a vivid color change occurring at the interface, and below, will permit an observer to obtain a direct reading of the level of the flowable material within a container by discerning where the interface is located.

As employed herein, the term “flowable material” is intended to mean any fluidic matter in which the shape of a given mass depends on the container but the volume is independent thereof. “Flowable material” is also intended to mean any fluidic matter which seeks a level and offers no permanent resistance to change of shape. The term may include any mass of granular material which has fluidic properties.

The expression “thermochromatic materials” as used herein is intended to mean materials that have or exhibit different colors or shades of color at different temperatures. The expression “responding chromatically” as used herein is intended to mean having or exhibiting different colors or shades of color at different temperatures.

### DESCRIPTION OF THE PRIOR ART

U.S. Pat. No. 3,696,675 issued Sep. 20, 1971 to GILMOUR teaches an external liquid level gauge adapted to be permanently affixed to the outside wall of a container for determining the liquid-gas interface within the container. The external liquid level gauge described in this patent consists of a uniform thermochromatic liquid crystalline material which coats the entire base layer of the gauge such that it is at right angles to the liquid-gas interface. The uniform thermochromatic material covers the entire temperature range to which the container is subjected within an overall range of −20° C. to 250° C. Depending upon the thermochromatic material selected, color changes over a gradient from violet to red can occur in a range as small as 2° C. to one as broad as 150° C. Since the temperature differential across the liquid-gas interface is generally small, on the order of less than 2° C., the change in color is slight across the interface. This is particularly the case when the container is placed outdoors and a large temperature range needs to be covered. As a result, it is difficult to visually locate the liquid-gas interface.

An improvement to the external liquid level gauge as taught in Gilmour '675 patent is disclosed in U.S. Pat. No. 4,358,955 which issued to the present inventor, RAIT, on Sep. 29, 1980. Here, the thermochromatic coated base layer is magnetically mounted to the outside wall of the container, and thus the external liquid level gauge can be repeatedly removed and replaced or relocated when necessary.

### SUMMARY OF THE INVENTION:

In accordance with one aspect of the present invention, there is provided an external liquid level gauge for externally determining the level of the interface between a mass of flowable material and the void volume above it within a container. The external liquid level gauge of the present invention is adapted to be affixed vertically to the outside wall of the container, extending along substantially the entire height.

In accordance with the present invention, the flowable material within the container has fluidic properties and it has a faster rate of heat transfer than the void volume above it within the container.

The external liquid level gauge, which is in the form of an elongated strip, comprises a layer of base material and a layer of thermochromatic materials. The base layer is adapted to be secured to the outside wall of the container and is such that it is in an intimate heat transfer relationship with the outside wall of the container. The thermochromatic layer overlies the layer of base material.

The thermochromatic layer comprises a light absorbing background and at least two regions of thermochromatic materials which are arranged upon the light absorbing background. The regions of at least two thermochromatic materials are disposed in arrays thereof and are arranged entirely along the length of the external liquid level gauge, in the vicinity between the bottom end and the top end. Furthermore, each of the thermochromatic materials is arranged in an individual area and each thermochromatic material responds chromatically within a different operating temperature range.

The flowable material within the container may be chosen from the group consisting of water, alcohol, oil, coffee, tea, juice, milk, liquefied gas and granular material.

In keeping with the present invention, the container to which the external liquid level gauge is adapted to be affixed may be chosen from the group of containers consisting of pressurized cylinders, open containers, sealed containers, cryogenic flasks and opaque vessels.

Typically, but not necessarily, the base material has adhesive or magnetic properties so as to permit the external liquid level gauge to be repeatedly removed and reattached to the container.

The external liquid level gauge may also include an ultra-violet filter layer which overlies the layer of thermochromatic materials.

The thermochromatic materials, in keeping with the present invention may be chosen from the group consisting of cholesteryl oleate, cholesteryl oleyl carbonate and mercurous oxide.

At least two thermochromatic materials in an array may have overlapping operating temperature ranges. Moreover, each of the thermochromatic materials in an array displays a color gradient within its operating temperature range.

Each thermochromatic material upon the light absorbing background is arranged in an individual array which may be chosen from the group of geometric configurations consisting of dots, circles, stars, squares, triangles, arrows, semi-circles, pentagons, hexagons, digits and letters.

In a particular embodiment of the present invention, the regions are arranged upon the light absorbing background such that one of the regions is positioned vertically down the center of the external liquid level gauge and at least one other region is arranged diagonally on each side.

In another embodiment of the present invention, the regions are arranged vertically in at least one array.

In yet another embodiment of the present invention, the regions are arranged diagonally in at least one array.

Still further, in another embodiment, the regions are arranged horizontally.

Typically, but not necessary, at least two adjacent regions are arranged to form a set and each set comprises at least two thermochromatic materials. Furthermore, each set is disposed vertically along the entire length of the external liquid level gauge in a repeated manner.

A further object of the present invention is to provide a method of determining the level of the interface between a mass of flowable material and the void volume above it within a container using an external liquid level gauge affixed to the outside wall of the container. The external liquid level gauge would be, of course, as described above. The method comprises the steps of:

(i) inducing heat transfer between the external liquid level gauge and the mass of flowable material within the container.

(ii) discerning visually a color change in at least one region of the array of the external liquid level gauge.

The region noted above which responds chromatically to a temperature change is contiguous to the mass of flowable material within the container. Specifically, step (i) may be achieved by any of the steps chosen from the group of steps consisting of:

(a) spraying a liquid onto the entire surface of the external liquid level gauge.

(b) wetting the entire surface of the external liquid level gauge with a moistened cloth or sponge.

(c) pouring a liquid down the entire surface of the external liquid level gauge.

(d) trickling a liquid down the entire surface of the external liquid level gauge.

(e) applying an electrically energized source along the entire length of the external liquid level gauge.

In one embodiment of the present invention, the liquid as employed above in any of steps (a) through (d) is a heat source. Since the temperature of the liquid is above the temperature of the flowable material within the container, heat transfer is induced from the liquid to the flowable material.

In another embodiment of the present invention, the liquid as employed above in any of steps (a) through (d) is a heat sink. Here, the temperature of the liquid is below the temperature of the flowable material within the container, thus heat transfer is induced from the flowable material to the liquid.

Particularly when at least two adjacent regions of the external liquid level gauge are arranged to form a set and when a plurality of such sets are disposed in a repeated manner vertically along the length of the external liquid level gauge, the method of determining the level of the interface between a mass of flowable material and the void volume above it within a container may also further comprise the step of:

(iii) estimating the level of the interface between the mass of flowable material and the void volume above the mass of flowable material within the container using the external liquid level gauge where the estimated area falls between a level having a profound color change and a level having a faint color change.

These and other objects of the present invention are discussed in greater detail hereafter, in association with the accompanying drawings.

### BRIEF DESCRIPTION OF THE DRAWINGS:

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a front view of an external liquid level gauge in keeping with the present invention, when affixed to the outside wall of a container;

FIG. 2 is a transverse sectional view taken on line II-II of the external liquid level gauge in keeping with the present invention as shown in FIG. 1, greatly enlarged;

FIG. 3 is a front view of the thermochromatic array of a first embodiment of the external liquid level gauge in keeping with the present invention;

FIG. 4 is a front view of the thermochromatic array of a second embodiment of the external liquid level gauge in keeping with the present invention;

FIG. 5 is a front view of the thermochromatic array of a third embodiment of the external liquid level gauge in keeping with the present invention;

FIG. 6 is a front view of the thermochromatic array of a fourth embodiment of the external liquid level gauge in keeping with the present invention;

FIG. 7 is a front view of the thermochromatic array of a fifth embodiment of the external liquid level gauge in keeping with the present invention, when affixed to the outside wall of the container; and

FIG. 8 is a front view of the thermochromatic array of a sixth embodiment of the external liquid level gauge in keeping with the present invention, when affixed to the outside wall of the container.

### DETAILED DESCRIPTION OF THE PREFERRED EMBODIMENTS:

The novel features which are believed to be characteristic of the present invention, as to its structure, organization, use and method of operation, together with further objectives and advantages thereof, will be better understood from the following discussion.

As noted above, a feature of the present invention is essentially to provide an external liquid level gauge for externally determining the level of the interface between a mass of flowable material and the void volume above it within a container.

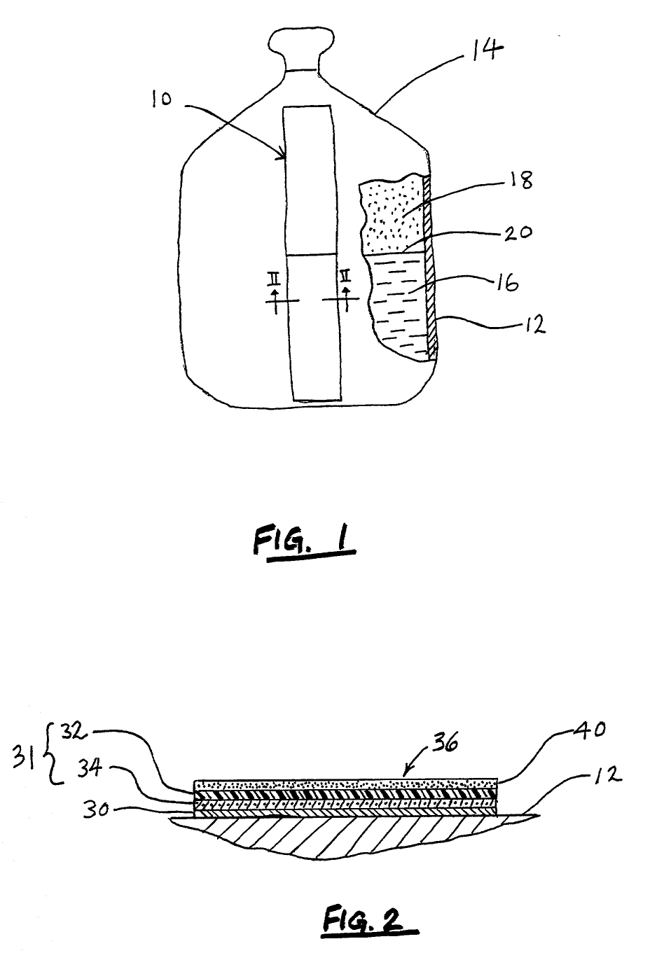

Referring first to FIG. 1, a front view of an external liquid level gauge 10 is shown. The external liquid level gauge 10 is affixed vertically to the outside wall 12 of a container 14, extending along substantially the entire height. The external liquid level gauge 10 is in the form of an elongated strip; it is in an intimate heat transfer relationship with the outside wall 12 of the container 14.

The container 14 is shown as being partially filled with a flowable material 16. The flowable material 16 is in intimate contact with the interior surface of the wall 12 and a void volume 18 is above the interface 20 of the flowable material 16.

The flowable material 16 within container 14 has fluidic properties, and it has a faster rate of heat transfer than the void volume 18 above it. A typical flowable material 16 within the container 14 may be water. Other flowable materials that may be found within the container 14 may be alcohol, oil, coffee, tea, juices, milk, liquefied gases—particularly such as carbon dioxide—or even granular materials.

It is noted that the container 14 to which the external liquid level gauge 10 is affixed may be a pressurized cylinder, an open container, a sealed container, a cryogenic flask, or an opaque container.

The external liquid level gauge 10 comprises a layer of base material 30 and a layer of thermochromatic materials 31 with reference to FIG. 2. The base layer 30 is adapted to be secured to the outside wall 12 of the container 14 and is such that it is in an intimate heat transfer relationship with the outside wall 12 of the container 14. Typically, the base layer 30 has adhesive or magnetic properties so as to permit the external liquid level gauge 10 to be repeatedly removed and reattached to the container 14. The thermochromatic layer 31 overlies the layer of base material 30.

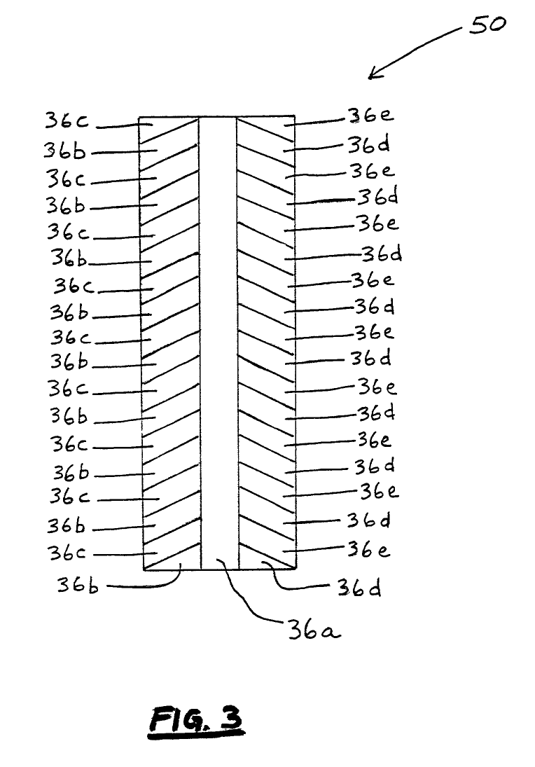

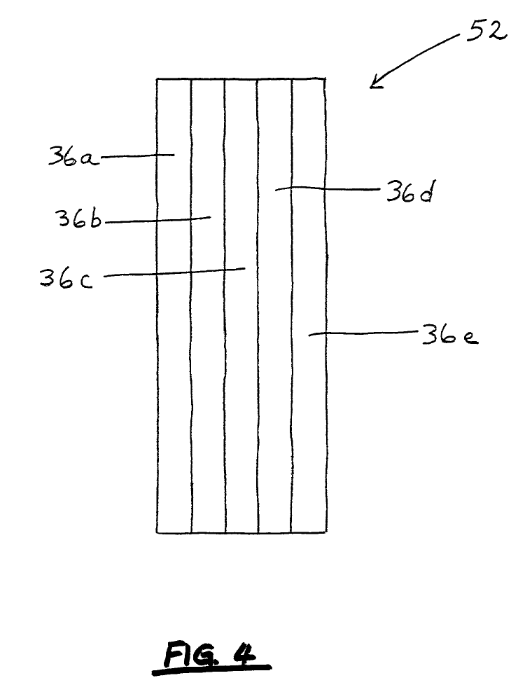

The thermochromatic layer 31 comprises a light absorbing background 34 and at least two regions 36 (FIG. 3) of thermochromatic materials 32 which are arranged upon the light absorbing background 34. The regions 36 of at least two thermochromatic materials 32 are arranged entirely along the length of the external liquid level gauge 10, in the vicinity between the bottom end and the top end. Furthermore, each of the thermochromatic materials 32 is arranged in an individual area 38 (not shown). The external liquid level gauge 10 may also include an ultra-violet filter layer 40 which overlies the layer of thermochromatic materials 31.

Thermochromatic materials 32 made by the Thermochromatic Liquid Crystal division of Thermographic Measurements Limited may be effectively employed. The thermochromatic materials 32 used are preferably reversible or thermotropic. Cholesteric liquid crystal compounds are most suitable. These compounds behave mechanically like liquids but exhibit the optical properties of crystals. They exhibit vivid color changes with only slight changes in temperature.

The thermochromatic materials 32 cover the entire temperature range to which the container 14 is subjected, within an overall range of −20° C. to 250° C. Some examples of thermochromataic materials 32 which may be employed are cholesteryl oleate, cholesteryl oleyl carbonate, and mercurous oxide. Each thermochromatic material 32 responds chromatically within a different operating temperature range. Cholesteryl oleate has an operating temperature range between 32.2° C. to 63.9° C. while cholesteryl oleyl carbonate has an operating temperature range between 29.2° C. to 39.2° C. Furthermore, each of the thermochromatic materials 32 displays a color gradient within its operating temperature range.

Typically, the light absorbing background 34 is a dark background. The light absorbing background 34 absorbs any light transmitted through the thermochromatic material 32 and allows selectively reflected light to be observed without light interference. Since each thermochromatic material 32 responds chromatically within a different temperature range, the selectively reflected light is determined by orientation change of the thermochromatic material 32 in response to temperature.

The additional ultra-violet filter layer 40 prevents the deterioration of the external liquid level gauge 10. It has been reported that long and continuous exposure to ultraviolet radiation causes the thermochromatic materials 32 to deteriorate and lose their temperature responsive chromatic characteristic which is necessary for the purpose of utilization as a liquid level gauge as described herein. This is particularly the case when the container 14 is placed outdoors where it is subjected to sunlight for a long period of time.

Depending upon the thermochromatic material 32 selected, color changes over a gradient can occur in a range as small as 2° C. to one as broad as 150° C. For a thermochromatic material 32 with a large operating temperature range, the color difference across the interface 20 is small.

As noted above, the rate of heat transfer is different between the mass of flowable material 16 and the void volume 18 above it such that for any container 14 with a modest heat conducting capability, the container wall 12 experiences a temperature gradient which is most pronounced at and below the interface 20 between a mass of flowable material 16 and the void volume 18 above it within a container 14. In other words, the temperature of the container wall 12 changes most abruptly at and below the level of the interface 20.

In an outdoor environment, the container 14 may be subjected to varying temperatures, from below 0° C. to over 37.8° C. In that particular case, the best results may be achieved by using five to seven different thermochromatic materials 32 in the external liquid level gauge 10 where each thermochromatic material 32 has an operating temperature range of about 8° C. In more stable environments such as a residence or an office-or even in stores, warehouses, and factories-where temperatures often fall between 16° C. to 29° C., two to five thermochromatic materials 32 are most effective. In such environments where temperatures range from about 16° C. to 27° C., two thermochromatic materials 32 with an operating temperature range of about 8° C. or five thermochromatic materials 32 with each having an operative temperature range of about 3° C. may also be effectively employed.

Moreover, the operating temperature ranges of at least two thermochromatic materials 32 in the external liquid level gauge 10 may be overlapped. A temperature response may be invoked from two thermochromatic materials 32 in the external liquid level gauge 10, thus making the level of the interface 20 between a mass of flowable material 16 and the void volume 18 above it within a container 14 easier to observe. For instance, the upper operating temperature of one thermochromatic material 32a may be 10° C., the temperature differential across the interface 20 may be 2° C., and the temperatures of the mass of flowable material 16 and the void volume 18 above it within the container 14 may be 9° C. and 11° C. respectively. On such occasion, a color change occurs for the end of the thermochromatic material 32a which responds to the lower operating temperature range while a color change also occurs for the adjacent end of the thermochromatic material 32b which responds within the higher operating temperature range. In order to determine the level of the interface 20, readings of both thermochromatic materials 32a and 32b are necessary. If two thermochromatic materials 32 having overlapping operating temperature ranges are employed, the level may be readily discerned visually.

Turning now to FIGS. 3 through 6, the regions 36 of at least two thermochromatic materials 32 are disposed in arrays thereof, designated by reference numerals 50, 52, 54, and 56.

Although not shown in the figures, each of the thermochromatic materials 32 is arranged upon the light absorbing background 34 in an individual area which may have any of the following geometric configurations such as dots, circles, stars, squares, triangles, arrows, semi-circles, pentagons, hexagons, digits, and letters.

As can be seen in FIG. 3, the thermochromatic array 50 comprises five thermochromatic materials 32a, 32b, 32c, 32d, and 32e which are arranged in respective regions 36a, 36b, 36c, 36d and 36e. The region 36a is positioned vertically down the center of array 50. Regions 36b and 36c are arranged on one side of the vertically positioned region 36a while regions 36d and 36e are arranged on the other side of region 36a. The four regions 36b, 36c, 36d, and 36e are arranged in a diagonal manner, repeatedly over the length of array 50. Thermochromatic material 32a has the lowest operating temperature range of the group of thermochromatic materials 32 found in array 50 while thermochromatic materials 32b and 32c have the next two highest operating temperature ranges, and thermochromatic materials 32d and 32e have the two most highest operating temperature ranges. The separation of the regions 36b, 36c, 36d, and 36e by region 36a provides a visual breadth between the lowest and highest temperatures to which array 50 may respond. Furthermore, it is preferred that the thermochromatic material 32a with the lowest operating temperature range exhibits a “cool” color such as blue and the thermochromatic material 32e with the highest operating temperature range exhibits a “hot” color such as red to aid in the locating of the interface 20 between the mass of flowable material 16 and the void volume 18.

For achieving the best results on outdoor use, each thermochromatic material 32 responds within a different operating temperature range, preferably of about 8° C. The five thermochromatic materials 32a, 32b, 32c, 32d and 32e are chosen such that the full range of all the operating temperature ranges covers the range of temperatures to which array 50 may be most likely exposed.

For optimum results, the upper temperature of thermochromatic material 32a may slightly overlap the lower limit of the operating temperature range of thermochromatic material 32b, and so on with each additional thermochromatic material 32 within array 50 sequentially to the thermochromatic material 32e which has the highest operating temperature range. For instance, by using this overlap system, a color change occurs in two adjacent thermochromatic materials 32a and 32b when the temperature at the interface 20 bridges the two thermochromatic materials 32a and 32b. Thus, the interface 20 is readily discerned visually.

When the external liquid level gauge 10 is placed indoors where the atmosphere is often controlled and potential temperature variations are generally much smaller than outdoors, the thermochromatic materials 32 in the array 50 may be chosen such that they have operating temperature ranges within the possible outer limits for thermochromatic materials 32 but also such that they have operating temperature ranges as small as 3° C.

Referring now to FIG. 4, a different embodiment of the present invention is shown. Thermochromatic array 52 comprises five thermochromatic materials 32a, 32b, 32c, 32d and 32e which are arranged in respective regions 36a, 36b, 36c, 36d and 36e vertically upon the light absorbing background 34.

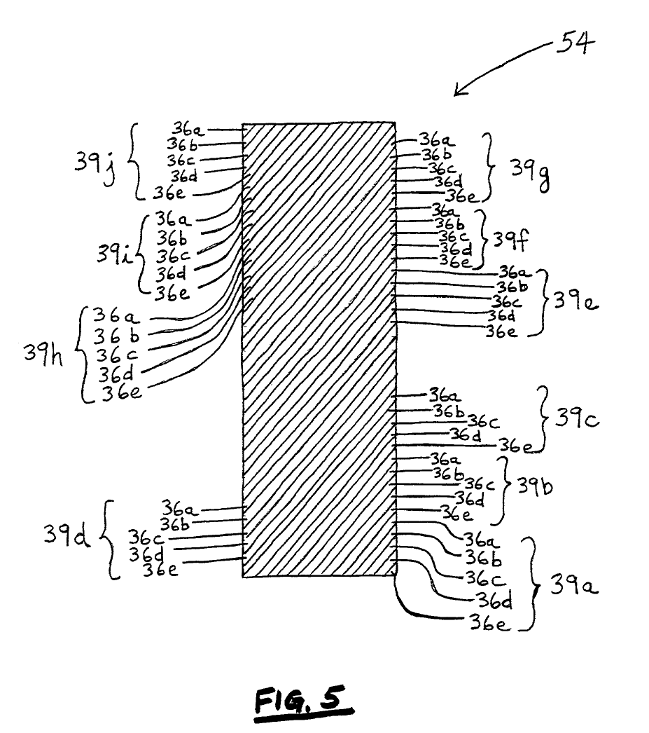

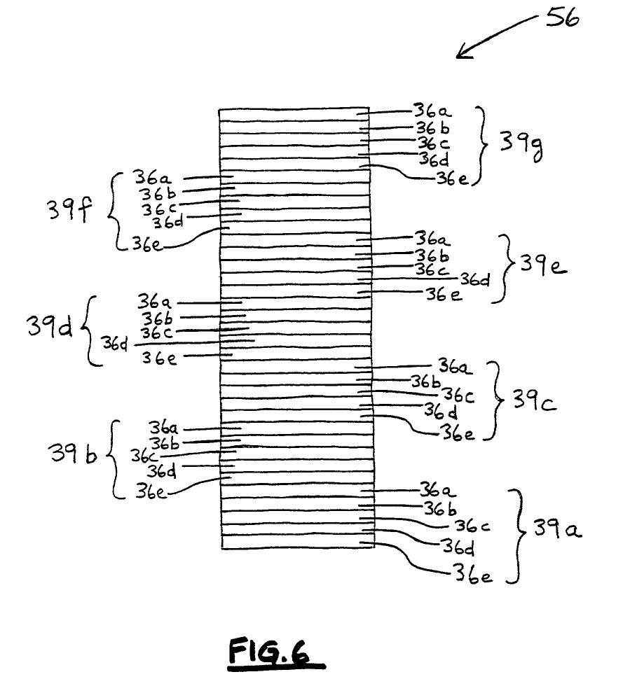

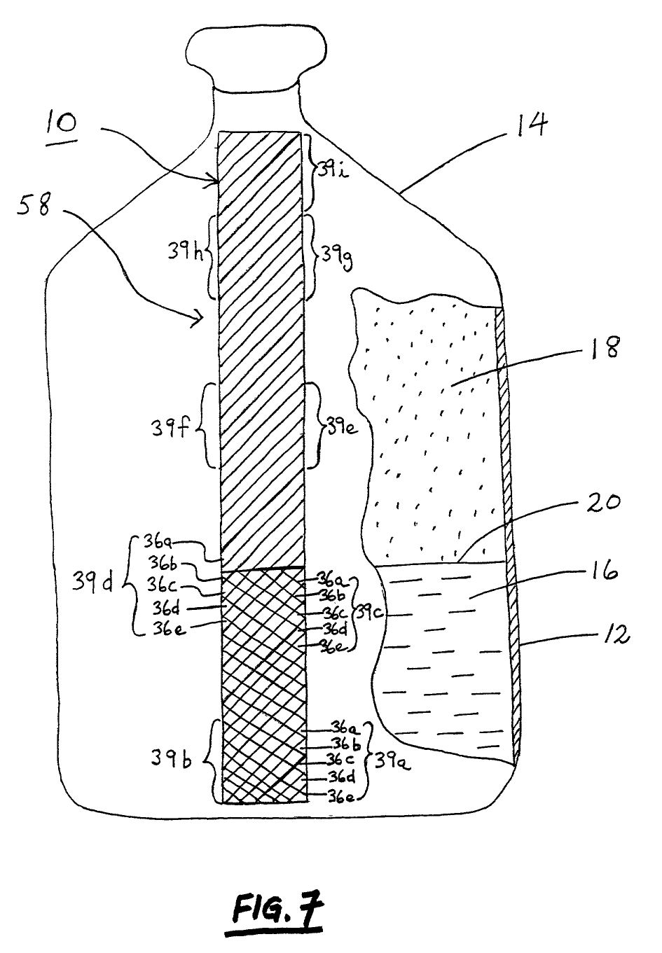

In another embodiment of the present invention shown in FIG. 5, the thermochromatic array 54 comprises five thermochromatic materials 32a, 32b, 32c, 32d and 32e which are disposed along the light absorbing background 34 in respective regions 36a, 36b, 36c, 36d and 36e. Here, the regions 36a, 36b, 36c, 36d and 36e are arranged in a diagonal manner, repeatedly over the entire length of array 54. The angle along the longitudinal axis of array 54 that the diagonal regions 36a, 36b, 36c, 36d and 36e are disposed may vary, but is preferably 45°. As can be seen particularly in FIG. 5 and the following FIG. 6, at least two adjacent regions 36 are combined to form a set 39 and a plurality of such sets 39 are disposed in a repeated manner vertically along the length of the external liquid level gauge 10.

Finally, referring to FIG. 6, the regions 36a, 36b, 36c, 36d and 36e comprising thermochromatic materials 32a, 32b, 32c, 32d and 32e respectively of array 56 are arranged in a horizontal manner. As noted above, the five regions 36a, 36b, 36c, 36d and 36e combine to form a set 39 and a plurality of such a set 39 are disposed along the length of array 56.

In keeping with the provisions of the present invention, applicant herein provides a method of determining the level of the interface 20 between a mass of flowable material 16 and the void volume 18 above it within a container 14 when the external liquid level gauge 10 is affixed to the outside wall 12 of the container 14.

In a steady state ambient environment, it is possible that little or no temperature differential exists at the interface 20 between the mass of flowable material 16 and the void volume 18 within the container 14. The addition or withdrawal of thermal energy to or from the container 14 and the mass of flowable material 16 is required to cause a temperature differential across the interface 20 to occur, and thus inducing a color change response from the thermochromatic materials 32 in turn. As noted above, the void volume 18 above the mass of flowable material 16 generally absorbs or releases far less thermal energy than the mass of flowable material 16, causing a measurable temperature differential at the interface 20.

Thus, the method of determining the interface 20 between the mass of flowable material 16 and the void volume 18 first comprises the step of inducing heat transfer between the external liquid level gauge 10 and the mass of flowable material 16 within the container 14. The occurrence of a temperature differential across the interface 20 will then induce a color change in at least one region 36 of the array of the external liquid level gauge 10, allowing the interface 20 to be readily discerned visually.

Specifically, the first step which involves the induction of heat transfer may be carried out by any of the steps chosen from the group of steps consisting of:

(a) spraying a liquid onto the entire surface of the external liquid level gauge 10;

(b) wetting the entire surface of the external liquid level gauge 10 with a moistened cloth or sponge;

(c) pouring a liquid down the entire surface of the external liquid level gauge 10;

(d) trickling a liquid down the entire surface of the external liquid level gauge 10;

(e) applying an electrically energized source along the entire length of the external liquid level gauge 10.

When the liquid as described above is a heat source, the temperature of the liquid is above the temperature of the flowable material 16 within the container 14, thus heat transfer is induced from the liquid to the flowable material 16. Indeed, steam from a steam gun may be employed if a large temperature gradient between the heat source and the flowable material 16 is desired. On the other hand, when the liquid is a heat sink, the temperature of the liquid is below the temperature of the flowable material 16 within the container 14, thus heat transfer is induced from the flowable material 16 to the liquid.

For the purpose of illustration, a large sealed container 14 with an external liquid level gauge 10 affixed to its outside wall 12 is placed in a warehouse or factory where the temperature generally falls between 5° C. and 35° C. The five thermochromatic materials 32a, 32b, 32c, 32d and 32e of the external liquid level gauge 10 are arranged in respective regions 36a, 36b, 36c, 36d and 36e as shown in array 58 with reference to FIG. 7. The operating temperature ranges of regions 36a, 36b, 36c, 36d and 36e are as follows:

| REGION | Operating Temperature Range |
|---|---|
| 36a | 0° C.-9° C. |
| 36b | 7° C.-16° C. |
| 36c | 14° C.-23° C. |
| 36d | 21° C.-30° C. |
| 36e | 28° C.-37° C. |

The flowable material 16 within container 14 is at a temperature of 15° C. In order to determine the level of the interface 20 between the flowable material 16 and the void volume 18 above it, a liquid which is at a temperature of 50° C. is sprayed onto the entire surface of the external liquid level gauge 10. Here, a temperature response is invoked from two regions 36b and 36c. A color change occurs in region 36b which responds to the upper limit of its operating temperature range while a color change also occurs for the adjacent region 36c which responds to the lower limit of its operating temperature range. Due to the overlapping operating temperature ranges of the regions 36, readings of both regions 36b and 36c are necessary to readily discern visually the level of the interface 20.

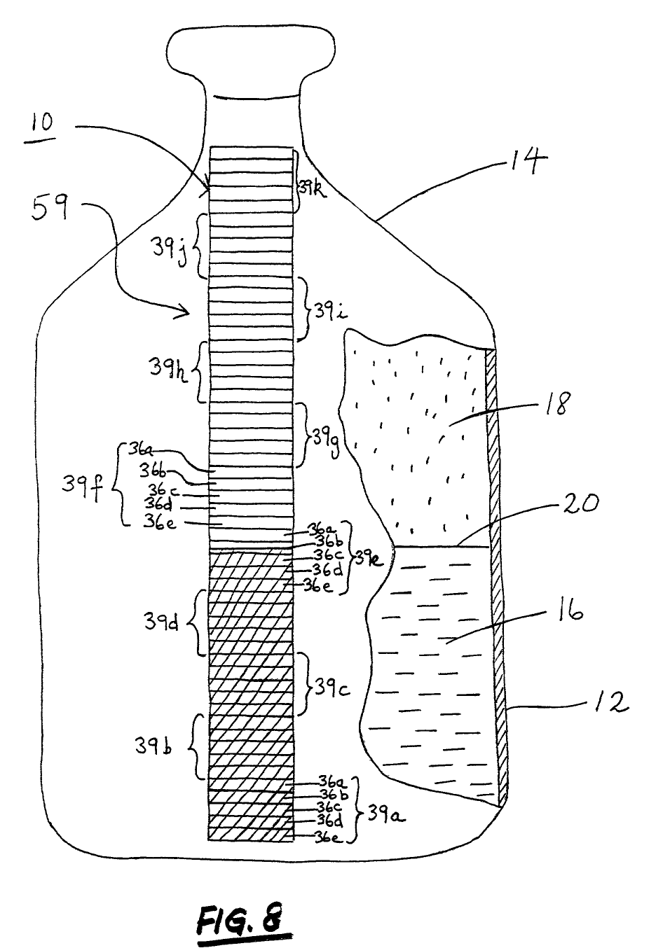

In yet another example, the external liquid level gauge 10 is affixed to the outside wall 12 of a large sealed container 14 which is exposed to the same environment as described above. The external liquid level gauge 10 also comprises five regions 36a, 36b, 36c, 36d and 36e which respond to the same operating temperature ranges as illustrated in the above Table. The only exception is that the regions 36a, 36b, 36c, 36d and 36e are arranged in a horizontal manner, as particularly seen in FIG. 8. Furthermore, the five regions 36a, 36b, 36c, 36d and 36e are combined to form a set 39 and a plurality of such a set 39 are disposed along the length of array 59. As shown in FIG. 8, eleven such sets 39a, 39b, 39c, 39d, 39e, 39f, 39g, 39h, 39i, 39j, and 39k are found in array 59 and the mass of flowable material 16 is contiguous to sets 39a, 39b, 39c, 39d and 39e. When the liquid (50° C.) is sprayed onto the entire surface of the external liquid level gauge 10, a temperature response is invoked from the two regions 36b and 36c in each of set 39a, 36a, 36b, 36c, 36d, 39e and 39f. Since the void volume 18 above the mass of flowable material 16 generally absorbs or releases far less thermal energy than the mass of flowable material 16, a color change in regions 36b and 36c of sets 39a, 39b, 39c, 39d and 39e is more pronounced than in regions 36b and 36c of set 39f. In order to determine the level of the interface 20 between the mass of flowable material 16 and the void volume 18 above it within container 14, the method further comprises the step of estimating the level of the interface 20 between the mass of flowable material 16 and the void volume 18 above it. The estimated area, in this case, falls between set 39e where the color change is profound and set 39f where the color change is faint.

The novel features which are believed to be characteristic of the present invention, as to its structure, organization, use and method of operation, together with further objectives and advantages thereof, will be better understood from the following discussion.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially along the entire height is intended to mean most but not necessarily all, as will be clear from the context in which such discussion occurs.

Moreover, use of the terms “he”, “him”, or “his”, is not intended to be specifically directed to persons of the masculine gender, and could easily be read as “she”, “her”, or “hers”, respectively.

What is claimed is:

1. An external liquid level gauge which is adapted to be affixed vertically to the outside wall of a container for use in the determination of the level of the interface between a mass of flowable material and the void volume above said mass of flowable material within a container, wherein said external liquid level gauge is adapted to extend along substantially the entire height of the container;
wherein said flowable material within the container has fluidic properties; and said flowable material has a faster rate of heat transfer than said void volume above it within the container;
said external liquid level gauge being in the form of an elongated strip which comprises a layer of base material and a layer of thermochromatic material;
wherein said layer of base material is adapted to be secured to the outside wall of a container in intimate heat transfer relationship with the outside wall of a container;
wherein said thermochromatic layer overlies said layer of base material;
said thermochromatic layer comprising a light absorbing background, and at least two regions of thermochromatic materials being arranged upon said light absorbing background;
wherein each of said at least two regions of thermochromatic materials is arranged in an individual area upon said light absorbing background and each of said thermochromatic materials responds chromatically within a different operating temperature range; and
wherein said regions of said at least two thermochromatic materials are disposed in arrays thereof arranged entirely along the length of said external liquid level gauge in the vicinity between the bottom end of said gauge and the top end of said gauge.

2. The external liquid level gauge of claim 1, wherein said flowable material is chosen from the group consisting of water, alcohol, oil, coffee, tea, juice, milk, liquefied gas, corrosive liquid and granular material.

3. The external liquid level gauge of claim 1, wherein said external liquid level gauge is adapted to be affixed to the outside wall of a container chosen from the group of containers consisting of pressurized cylinders, open containers, sealed containers, cryogenic flasks, and opaque vessels, so as to determine the level of the interface between said mass of flowable material and said void volume above said mass of flowable material within the container to which said external liquid level gauge is to be affixed.

4. The external liquid level gauge of claim 1, wherein said base material additionally has adhesive or magnetic properties so as to permit said external liquid level gauge to be repeatedly removed and reattached to the outside wall of a container.

5. The external liquid level gauge of claim 1, further comprising an ultra-violet filter layer, wherein said ultra-violet filter layer overlies said layer of thermochromatic materials.

6. The external liquid level gauge of claim 1, wherein said thermochromatic materials are chosen from the group consisting of cholesteric liquid crystal compounds and mercurous oxide.

7. The external liquid level gauge of claim 1, wherein said at least two thermochromatic materials in said array have overlapping operating temperature ranges.

8. The external liquid level gauge of claim 1, wherein each of said thermochromatic materials in said array displays a color gradient within its operating temperature range.

9. The external liquid level gauge of claim 1, wherein each of said thermochromatic materials is arranged upon said light absorbing background in said individual area chosen from the group of geometric configurations consisting of dots, circles, stars, squares, triangles, arrows, semi-circles, pentagons, hexagons, digits and letters.

10. The external liquid level gauge of claim 1, wherein said regions are arranged upon said light absorbing background such that one said region is positioned vertically down the center of said gauge and at least one other region is arranged diagonally on each side of said vertically positioned region of said gauge in said at least one array.

11. The external liquid level gauge of claim 1, wherein said regions are arranged vertically in said at least one array.

12. The external liquid level gauge of claim 1, wherein said regions are arranged diagonally in said at least one array.

13. The external liquid level gauge of claim 1, wherein said regions are arranged horizontally in said at least one array.

14. The external liquid level gauge of claim 1, wherein said at least two adjacent regions are arranged to form a set; said set comprises said at least two thermochromatic materials.

15. The external liquid level gauge of claim 14, wherein said set is disposed vertically along the entire length of said external liquid level gauge in a repeated manner.

16. A method of determining the level of the interface between a mass of flowable material and the void volume above said mass of flowable material within a container using an external liquid level gauge;
wherein said flowable material within said container has fluidic properties; and said flowable material has a faster rate of heat transfer than said void volume above it within said container;
wherein said external liquid level gauge is affixed vertically to the outside wall of said container;
wherein said external liquid level gauge extends along substantially the entire height of said container;
said external liquid level gauge being in the form of an elongated strip comprises a layer of base material and a layer of thermochromatic material;
wherein said layer of base material is secured to said outside wall of said container in intimate heat transfer relationship with said outside wall of said container;
wherein said thermochromatic layer overlies said layer of base material;
said thermochromatic layer comprising a light absorbing background, and at least two regions of thermochromatic materials being arranged upon said light absorbing background;
wherein each of said at least two regions of thermochromatic materials is arranged in an individual area upon said light absorbing background and each of said at least two thermochromatic materials responds chromatically within a different operating temperature range;
wherein said regions of thermochromatic materials are disposed in arrays thereof arranged entirely along the length of said external liquid level gauge in the vicinity between the bottom end of said gauge and the top end of said gauge;
said method comprising the steps of:
(i) inducing heat transfer between said external liquid level gauge and said mass of flowable material within said container;
(ii) discerning visually a color change in said at least one region of said array of said external liquid level gauge;
(iii) wherein said region which responds chromatically to a temperature change is contiguous to said mass of flowable material within said container;
wherein step (i) is achieved by any of the steps chosen from the group of steps consisting of:
(a) spraying a liquid onto the entire surface of said external liquid level gauge affixed to said outside wall of said container;
(b) wetting the entire surface of said external liquid level affixed to said outside wall of said container with a moistened cloth or sponge;
(c) pouring a liquid down the entire surface of said external liquid level gauge affixed to said outside wall of said container;
(d) trickling a liquid down the entire surface of said external liquid level gauge affixed to said outside wall of said container; and
(e) applying an electrically energized source along the entire length of said external liquid level gauge affixed to said outside wall of said container.

17. The method of claim 16, wherein said liquid in any of steps (a) through (d) is a heat source; and wherein said liquid is at a temperature which is above the temperature of said flowable material within said container so as to induce heat transfer from said liquid to said flowable material within said container.

18. The method of claim 16, wherein said liquid in any of steps (a) through (d) is a heat sink; and wherein said liquid is at a temperature which is below the temperature of said flowable material within said container so as to induce heat transfer to said liquid from said flowable material within said container.

19. The method of claim 16, wherein said at least two adjacent regions are arranged to form a set; said set comprises said at least two thermochromatic materials.

20. The method of claim 19, wherein said set is disposed vertically along the entire length of said external liquid level gauge in a repeated manner.

21. The method of claim 20, wherein said plurality of sets are disposed in a repeated manner vertically along the length of said external liquid level gauge, and said method further comprises the step of:
(iii) estimating the level of the interface between said mass of flowable material and said void volume above said mass of flowable material within said container using said external liquid level gauge; wherein the estimated area falls between a level having a profound color change and a level having a faint color change.
